(19) United States
(12) Patent Application Publication
(10) Pub. No.: US 2024/0150096 A1
(43) Pub. Date: May 9, 2024

(54) Laminate Construct, Blanks And Containers Formed Therefrom, Sealing Apparatus Therefor, And Associated Methods

(71) Applicant: Graphic Packaging International, LLC, Atlanta, GA (US)

(72) Inventors: Nils Lagerwall, Genarp (SE); Simon Holka, Staffanstorp (SE); Stefan Bengtsson, Furulund (SE)

(21) Appl. No.: 18/386,287

(22) Filed: Nov. 2, 2023

Related U.S. Application Data
(60) Provisional application No. 63/422,631, filed on Nov. 4, 2022.
(60) Provisional application No. 63/448,794, filed on Feb. 28, 2023.

(51) Int. Cl. B65D 65/40; B29C 65/00; B29C 65/04; B31B 50/66; B32B 27/08; B32B 27/10; B32B 27/32; B32B 27/36; B65D 43/16

(52) U.S. Cl. CPC B65D 65/40; B29C 65/04; B29C 66/851; B31B 50/66; B32B 27/08; B32B 27/10; B32B 27/32; B32B 27/36; B65D 43/169; B29L 2031/7162; B32B 2255/10; B32B 2255/20; B32B 2270/00; B32B 2307/518; B32B 2307/718; B32B 2439/62

(57) ABSTRACT

A laminate structure for forming a barrier member of a container, the laminate structure includes a base layer, a barrier film layer, a first functional polymer layer, and a second functional polymer layer configured to at least partially seal the laminate structure to a container wall of the container, the first functional polymer layer reactive to the application of radiofrequency energy for promoting joining the second functional polymer layer to the container wall of the container. Also disclosed is a sealing assembly for joining a barrier member to a container.

### CROSS-REFERENCE TO RELATED APPLICATION

The present application claims the benefit of each of U.S. Provisional Patent Application No. 63/422,631, filed on Nov. 4, 2022, and U.S. Provisional Patent Application No. 63/448,794, filed on Feb. 28, 2023.

### INCORPORATION BY REFERENCE

The disclosures of each of U.S. Provisional Patent Application No. 63/422,631, filed on Nov. 4, 2022, and U.S. Provisional Patent Application No. 63/448,794, filed on Feb. 28, 2023, are hereby incorporated by reference for all purposes as if set forth in their entireties.

### BACKGROUND OF THE DISCLOSURE

The present disclosure generally relates to laminate structures/blanks, containers formed therefrom, and associated methods. More specifically, the present disclosure relates to laminate structures/blanks, containers formed therefrom, and associated methods in which the laminate structure includes at least one functional polymer layer that is reactive to the application of RF energy.

### SUMMARY OF THE DISCLOSURE

According to one aspect, the disclosure is generally directed to a laminate structure for forming a barrier member of a container, the laminate structure comprising a base layer, a barrier film layer, a first functional polymer layer, and a second functional polymer layer configured to at least partially seal the laminate structure to a container wall of the container, the first functional polymer layer reactive to the application of radiofrequency energy for promoting joining the second functional polymer layer to the container wall of the container.

According to another aspect, the disclosure is generally directed to a container for holding one or more products, the container comprising a container body comprising a container wall extending at least partially around an interior of the container, a top end, a bottom end, and a barrier member positioned in the interior of the container. The barrier member comprises a base layer, a barrier film layer, a first functional polymer layer, and a second functional polymer layer configured to at least partially seal the laminate structure to the container wall of the container, the first functional polymer layer reactive to the application of radiofrequency energy for promoting joining the second functional polymer layer to the container wall of the container.

According to another aspect, the disclosure is generally directed to a method of forming a container for holding one or more products, the method comprising obtaining a container wall, positioning the container wall extending at least partially around an interior of the container and such that the container has a top end and a bottom end, and obtaining a barrier blank, the barrier blank comprising a base layer, a barrier film layer, a first functional polymer layer, and a second functional polymer layer, the first functional polymer layer reactive to the application of radiofrequency energy. The method further comprises positioning the barrier blank at least partially in the interior of the container, and applying radiofrequency energy to the barrier blank to join the second functional polymer layer to the container wall of the container.

According to another aspect, the disclosure is generally directed to a sealing assembly for sealing a portion of a barrier blank to a container wall, the sealing assembly comprising, a receiving assembly, the receiving assembly comprising a support defining an opening, and a receiving conductive member positioned extending at least partially around the opening, and a transmitting assembly, the transmitting assembly comprising a transmitting conductive member defining a first electrode feature, a reciprocating member, a flexible member defining a sealing feature and positioned between the conductive member, and a plunger plate defining a second electrode feature, the transmitting assembly movably supported relative to the receiving assembly such that the transmitting assembly is for being aligned with the receiving conductive member in the opening of the support so that at least one radiofrequency wave is for being transmitted from the first electrode feature and the second electrode feature of the transmitting assembly to the conductive member of the receiving assembly.

According to another aspect, the disclosure is generally directed to a method of sealing a barrier blank to a container wall of a container, the method comprising obtaining a sealing assembly, the sealing assembly comprising a receiving assembly, the receiving assembly comprising a support defining an opening, and a receiving conductive member positioned extending at least partially around the opening, and a transmitting assembly, the transmitting assembly comprising a transmitting conductive member defining a first electrode feature, a reciprocating member, a flexible member defining a sealing feature and positioned between the conductive member, and a plunger plate defining a second electrode feature, the transmitting assembly movably supported relative to the receiving assembly. The method further comprises aligning the transmitting assembly with the receiving conductive member in the opening of the support, positioning a barrier blank and a container wall at least partially between the transmitting assembly and the receiving assembly, and transmitting at least one radiofrequency wave from the first electrode feature and the second electrode feature of the transmitting assembly to the conductive member of the receiving assembly to heat one or more portions of the barrier blank.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a cross-sectional schematic view of a laminate structure for use in forming blanks and containers according to the present disclosure.

FIG. 1A is a cross-sectional schematic view of the laminate structure of FIG. 1 being subjected to the application of radiofrequency energy.

FIG. 2 is a perspective view of a container at least partially formed from the laminate structure of FIGS. 1 and 1A.

FIG. 3 is a perspective view of a sealing assembly according to an exemplary embodiment of the disclosure.

FIG. 4 is a perspective view of a receiving assembly of the sealing assembly of FIG. 3.

FIG. 5 is a perspective view of a transmitting assembly of the sealing assembly of FIG. 3.

FIG. 6 is an exploded perspective view of the transmitting assembly of FIG. 5.

FIG. 7 is a perspective view of a conductive member of the transmitting assembly of FIG. 5.

FIG. 8 is a perspective view of a reciprocating member of the transmitting assembly of FIG. 5.

FIG. 9A is a perspective view of a flexible member of the transmitting assembly of FIG. 5 in a first configuration.

FIG. 9B is a perspective view of a flexible member of the transmitting assembly of FIG. 5 in a second configuration.

FIG. 10 is a perspective view of a plunger plate of the transmitting assembly of FIG. 5.

FIG. 11 is a cross-sectional view of a first configuration of the sealing assembly of FIG. 3 during a sealing operation.

FIG. 12 is a cross-sectional view of a second configuration of the sealing assembly of FIG. 3 during a sealing operation.

Corresponding parts are designated by corresponding reference numbers throughout the drawings.

### DETAILED DESCRIPTION OF THE EXEMPLARY EMBODIMENTS

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the containers may be interchanged. Thus, while only certain combinations are illustrated herein, numerous other combinations and configurations are contemplated hereby.

Containers according to the present disclosure can accommodate articles of numerous different shapes. For the purpose of illustration and not for the purpose of limiting the scope of the disclosure, the following detailed description describes articles such as food products at least partially disposed upon or within the container embodiments.

The articles can include articles such as flowable products or materials, e.g., granular materials/materials with a relatively small particle size, such as flowable food products. In one embodiment, articles described herein can be flowable products such as, e.g., baby formula, ground coffee, powdered nutritional supplements, cereal, granola, trail mix, candy, pasta, or any other food product such as liquid or powdered food or beverage products. In other embodiments, the flowable products could be nonfood productions (e.g., detergent, cat litter, etc.) without departing from the disclosure.

In this specification, the terms “inner,” “interior,” “outer,” “exterior,” “lower,” “bottom,” “upper,” and “top” indicate orientations determined in relation to fully erected and upright containers.

As described herein, containers may be formed by multiple overlapping panels, end flaps, and/or other portions of blanks. Such panels, end flaps, and/or other portions of the blanks can be designated in relative terms to one another, e.g., “first”, “second”, “third”, etc., in sequential or non-sequential reference, without departing from the disclosure.

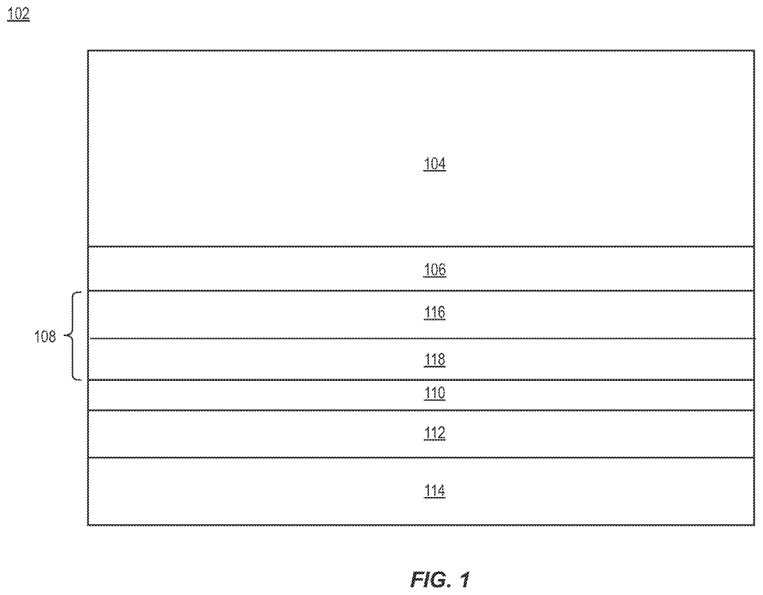

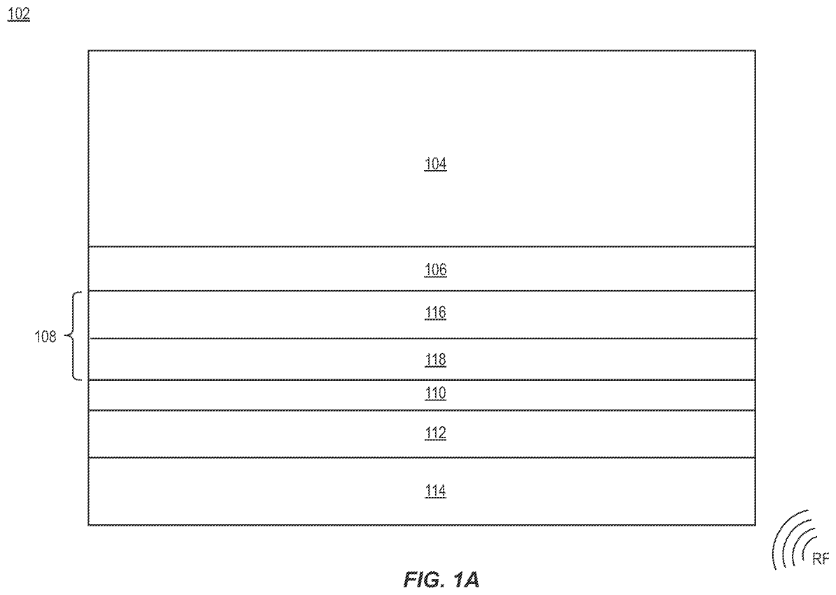

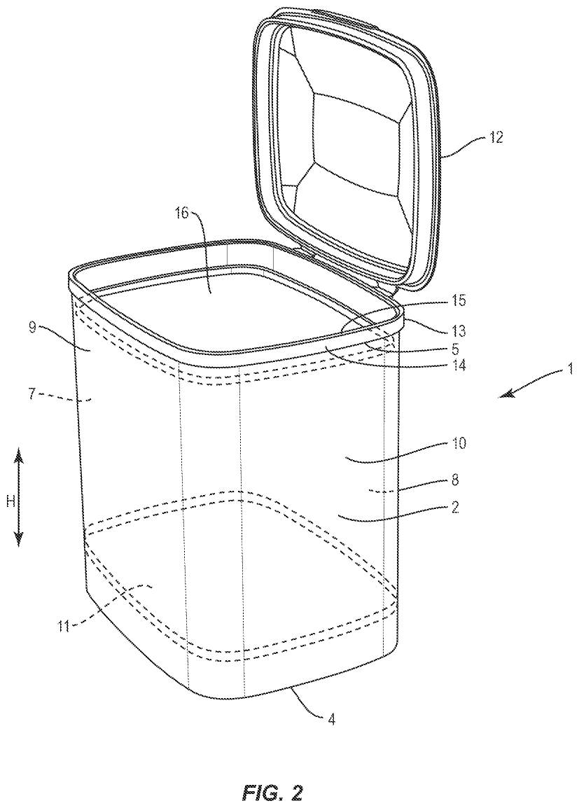

Referring to FIG. 1, a schematic cross-sectional view of a laminate structure 102 for at least partially forming a blank and/or a container 1 (FIG. 2) is illustrated according to an exemplary embodiment of the disclosure. The container 1 can be used to support or hold one or more flowable products as described above.

As shown, the laminate structure 102 can include a base layer 104, an adhesive layer 106 applied to the base layer 104, a barrier film layer 108 applied to the adhesive layer 106 and the base layer 104 thereby, a primer layer 110 applied to the barrier film 108, a first functional polymer layer 112 applied to the primer layer 110 and configured with adhesion properties upon being subject to radiofrequency (RF) energy, and a second functional polymer layer 114 applied to the first functional polymer layer and configured to seal one or more portions of the laminate structure 102.

The base layer 104 can be a composite material, such as a paper or paper-based product (e.g., paperboard, etc.) and supports one or more of the adhesive layer 106, the barrier film layer 108, the primer layer 110, the first functional polymer layer 112, and the second functional polymer layer 114. Accordingly, the base layer 104 can be generally configured to be the same size, shape, and/or dimensions as one or more of those components, though the base layer 104 can be differently-configured without departing from the disclosure. In some embodiments, the base layer 104 can provide mechanical strength, printability, and recyclability to the laminate structure 102 and containers formed therefrom.

The adhesive layer 106 can comprise one or more adhesives such as solvent-based polyurethane adhesives. In some embodiments, such adhesives can be from the reaction of organic (poly) diisocyanates with (oligomeric) diol compounds, which leads to urethane linkages in the associated backbone (—NH—C(═O)—O—).

In some embodiments, the adhesive layer 106 can be applied to the base layer 104 and/or to the barrier film layer 108 through an extrusion process to provide high inter-ply adhesion among applications of the adhesive that forms that adhesive layer 106.

In one embodiment, the adhesive layer 106 can be applied in an amount corresponding to about 2-4 g/m², thought it will be understood that the adhesive layer 106 can be provided in a different configuration and/or amount without departing from the disclosure.

The barrier film layer 108 can include a carrier film portion 118 and a barrier coating portion 116 applied to the carrier film portion 118. In the illustrated embodiment, the barrier coating portion 116 can be provided facing the adhesive layer 106 and the carrier film portion 118 can be provided facing the primer layer 110, though a different arrangement of the barrier film layer 108 can be provided without departing from the disclosure.

In some embodiments, the carrier film portion 118 of the barrier film layer 108 can be configured as a carrier film, typically, a bi-axially oriented polyentereftalat (BOPET) or bi-axially-oriented polypropylene (BOPP) layer. The carrier film portion 118 can be provided in a thickness of about 8 microns to about 25 microns, though the carrier film portion 118 can have a different configuration and/or arrangement without departing from the disclosure.

In some embodiments, the barrier coating portion 116 of the barrier film layer can include one or more barriers vacuum deposited on the carrier film portion 118 and that can include aluminum, silicone oxide (SiOx), and/or aluminum oxide (AlOx). In some embodiments, the barrier coating portion 116 can be at least partially protected from mechanical damage, e.g., material stresses, stresses incidental to the formation of the laminate structure 102, etc., with one or more additional protective coatings.

The aforementioned barrier film layer 108 can be provided with beneficial environmental impact profile compared to, for example, another layer configuration such as that of aluminum foil. In some embodiments, the barrier film layer 108 can have an oxygen transmission rate of less than 0.1 cm³/m²/day (in an environment at 1 atm pressure, 23° C., and 50% relative humidity), and a water vapor transmission rate of less than 0.1 g/m²/day (in an environment at 25° C. and 75% relative humidity).

Optionally, a primer layer 110 can be applied to the barrier layer film 108. In some embodiments, the primer layer 110 can be a water-based primer provided in an amount of about 0.05 to about 0.2 g/m². Lower amounts of the primer layer 110 can be applied, for example, in embodiments in which lower coating weights of the first functional polymer layer 112 and/or the second functional polymer layer 114 are applied.

The first functional polymer layer 112 can be applied to the primer layer 110, or, in some embodiments, directly to the barrier film layer 108. In some embodiments, the first functional polymer layer 112 can comprise a copolymer of ethylene and methyl acrylate, for example, having a methyl acrylate content above about 15% by weight. It will be understood that the first functional polymer layer can be configured as reactive to the application of radiofrequency energy (RF) to effect one or more changes thereof, as described further herein. In some embodiments, the first functional polymer layer 112 can be applied in an amount of about 2 g/m² to about 50 g/m².

In the illustrated embodiment, the second functional polymer layer 114 can be comprised of one or materials that include polyolefins such as polyethylene (e.g., LDPE, LLDPE, mLLDPE, plastomers, etc.). In some embodiments, the second functional polymer layer 114 can be provided in an amount of about 2 g/m² to about 50 g/m².

In some embodiments, the first functional polymer layer 112, and the second functional polymer layer 114 can be applied to the base layer 104/adhesive layer 106/barrier film layer 108 substrate through coextrusion. Such coextrusion of the layers 112, 114 can minimize the total use of involved polymeric material.

With additional reference to FIG. 1A, and as described herein, formation of the laminate structure 102 can include the application of radiofrequency (RF) energy, e.g., electromagnetic waves in the range of about 10 GHz to about 300 GHz. In some embodiments, the laminate structure 102 can be subject to electromagnetic waves in the range of about 10 MHz and about 50 MHz. In some embodiments, electromatic waves in the range of about 20 MHz to about 30 MHz can be applied to the laminate structure 102.

Such application of RF energy to the laminate structure 102 can cause dipoles in the first functional polymer layer 112 to realign in the presence of an alternative electric field, inducing molecular rotation and subsequent intermolecular friction to generate heat in the first functional polymer layer 112.

In this regard, RF energy can be applied to the laminate structure 102 to cause the first functional polymer layer 112 to react so as to at least partially heat, soften, melt, etc., so as to have adhesive properties that join the layers of the laminate structure 102. In some embodiments, such heating of the first functional polymer layer 112 promotes joining of the second functional polymer layer 114 to the remainder of the laminate structure 102 so as to form a sealing film or barrier thereon.

Accordingly, the laminate structure 102 is configured such that the application of RF energy thereto can promote sealing and joining of the laminate structure 102 while minimizing the use of traditional adhesives for such purpose.

It will be understood that one or more components of the laminate structure 102 can have a different configuration and/or arrangement without departing from the disclosure.

Upon formation of the laminate structure 102 as described herein, the laminate structure 102 can be cut, folded, and/or otherwise shaped to form blanks or other substrates from which one or more containers can be formed therefrom.

Turning to FIG. 2, there is shown a container at least partially formed from the laminate structure 102 in the form of a paperboard packaging container 1 for products such as bulk solids. The particular shape of the container 1 shown in the figures should not be considered limiting. Accordingly, the paperboard packaging container according to the present disclosure may have any desired shape or size to suit a desired purpose.

The packaging container 1 comprises a container body 2 formed by a tubular container wall 3, which, in some embodiments, can be comprised from the laminate structure 102. The container wall 3 extends from a bottom end 4 to a top end 5 at a container body opening in a height direction H of the packaging container 1. The container wall 3 has an inner surface 7 facing towards an inner compartment 8 (broadly, “interior”) in the packaging container 1 and an outer surface 9 facing away from the inner compartment 8 and being exposed to the exterior of the packaging container 1.

The container body 2 may be formed by bringing together the side edges of a section of a laminate structure or another material together causing the material to assume a tubular shape, and sealing the side edges together. Sealing of the side edges may be made by any suitable method as known in the art, such as by welding or gluing, with welding being preferred. Sealing of the side edges of the container body web may involve using a sealing strip. as known in the art. The container body may be formed into any desired tubular shape including circular, oval, polygonal, including rectangular and modified rectangular shapes, such as the modified rectangular shape with rounded corners which is shown in the figures.

The packaging container 1 can be closed at the bottom end 4 by means of a base disc 11 attached proximate the bottom end 4 of the container body 2. The base disc 11 may comprises a laminate base sheet material. Such base sheet material may comprise a structural layer, for example a carton layer, and a thermoplastic welding layer. The base sheet material may optionally be the same type as the laminate structure 102.

The base disc 11 is attached to the container wall 3 by folding an edge portion out of the plane of the base disc 11, bringing the folded edge portion into alignment with the inner surface 7 of the container wall 3 and welding or otherwise attaching the folded edge portion of the base disc 11 to the inner surface 7 of the container wall 3 to form a coherent seal between the base disc 11 and the container wall 3.

The packaging container 1 may be provided with a bottom rim (not shown) which is attached to the inner surface 7 of the container wall 3, between the base disc 11 and the bottom end 4 of the container body 2. The bottom rim may reinforce the bottom edge of the container body 2 and may protect the container body bottom edge from mechanical deformation.

The packaging container 1 is provided with a closure arrangement comprising a lid 12 and an upper reinforcing rim 13 extending along the periphery of the container body opening 6, the upper reinforcing rim 13 being hingedly connected to the lid 12.

The upper reinforcing rim 13 may be a plastic rim, such as a thermoplastic rim and is attached to the inner surface 7 of the container body wall 3 at the container body opening 6. The upper reinforcement rim 13 may alternatively be a molded rim comprising pulp fibers. Similarly, the lid may be a plastic lid or a molded lid comprising pulp fibers,

The paperboard packaging container 1 may be an all-paperboard packaging container, e.g., so as to be avoid of polymeric and/or metallic materials.

The provision of at least an upper reinforcing rim, ascertains that the wall portions retain a selected shape such as an outward curvature which may prevent the wall portions from bulging inwards. Inwardly bulging wall portions is a phenomenon known to occur in paperboard packaging containers and presents a problem in that it may negatively affect the stability and crush resistance of the packaging container. The reinforcing rim is an optional component of the paperboard containers as disclosed herein.

The upper reinforcing rim 13 has an extension in the height direction, H, of the container 1 and has a lower rim edge 14 facing towards the container bottom end 4 and an upper rim edge 15 facing away from the container bottom end 4.

The upper reinforcing rim 13 is joined to the inner surface 7 of the container wall 3 e.g., by means of a weld seal extending around the container body opening. The weld seal preferably extends continuously around the container body opening to provide a seal between the upper reinforcing rim 13 and the container wall 3. The seal is preferably sift-proof, more preferably moisture proof and most preferably gas-tight.

The inner compartment 8 of the packaging container is sealed with a fully or partly removable inner sealing member 16 (broadly, “barrier member” or “barrier blank”) which constitutes a transport seal over packaged bulk solids and which is sealed to the inner surface of container body wall 3 by being welded thereto. The removable inner sealing member 16 may be attached to the container body wall 3 either from the top end 5 of the container body 2 or from the bottom end 4 of the container body 2. To gain a first access to the packaged bulk solids, a user opens the lid 13 and exposes the packaged bulk solids by fully or partly removing the inner sealing member 16.

The inner sealing member 16 may comprise a laminate sealing member sheet material comprising a structural layer, such as carton or aluminum foil, and a thermoplastic welding layer. In this regard, and as described further herein, the inner sealing member 16 can be at least partially formed from the laminate structure 102.

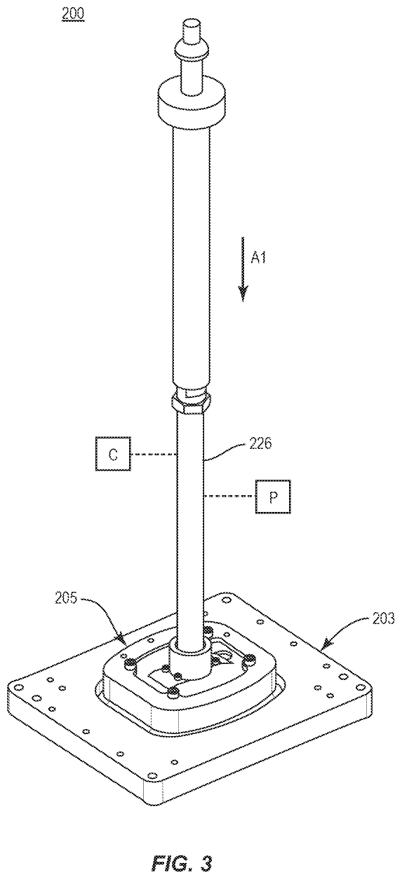

Referring additionally to FIG. 3, a sealing assembly for use with one or more laminate structures is generally designated 200. The sealing assembly 200 can be used with the laminate structure 102 individually and/or the remainder of the packaging container 1 described herein, or could be used with a differently configured laminate structure and/or packaging container without departing from the disclosure.

As shown in FIG. 3, the sealing assembly 200 can include a receiving assembly 203 and a transmitting assembly 205. As described further herein, the receiving assembly 203 and the transmitting assembly 205 can be configured to receive and transmit, respectively, electromagnetic waves.

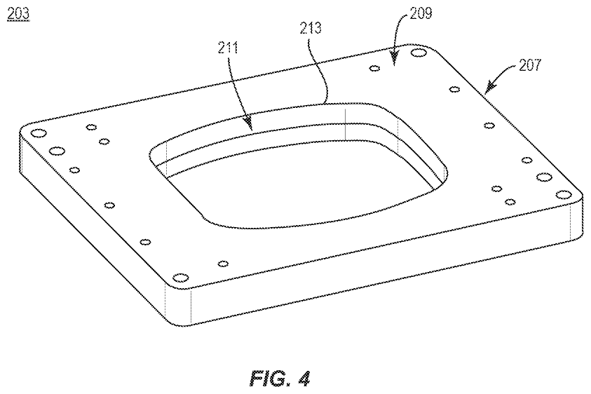

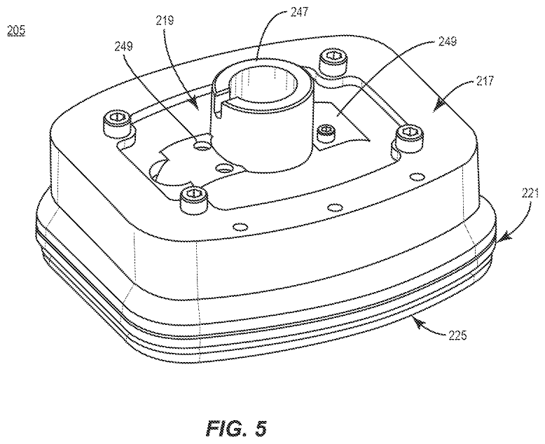

With additional reference to FIGS. 4-6, the receiving assembly 203 can include a support 207 having a body 209, with a receiving conductive member 211 attached to the body 209.

As shown, the body 209 of the support 207 can define/extend at least partially around an opening 213 that is configured and dimensioned for at least partially receiving a portion of the transmitting assembly 205. In some embodiments, the support 207/body 209 can be formed of an at least partially electrically insulating material, e.g., a polymeric and/or composite material.

In some embodiments, the receiving conductive member 211 can be attached to a portion of the body 209 surrounding the opening 213, e.g., such that the receiving conductive member 211 can extend at least partially around the opening 213. In some embodiments, the receiving conductive member 211 can be adhered to an exterior surface of the support 207/body 209, and in some embodiments, the receiving conductive member 211 can be at least partially recessed within the body 209, e.g., in a trench or channel formed therealong. The receiving conductive member 211 can be formed of an at least partially electrically conductive material, for example, a metallic material such as copper.

In this regard, the receiving conductive member 211 can have an at least partially ring-like/annular arrangement. As described further herein, the receiving conductive member 211 can have the general configuration of a loop antenna for receiving one or more electromagnetic waves transmitted by/emanating from the transmitting assembly 205.

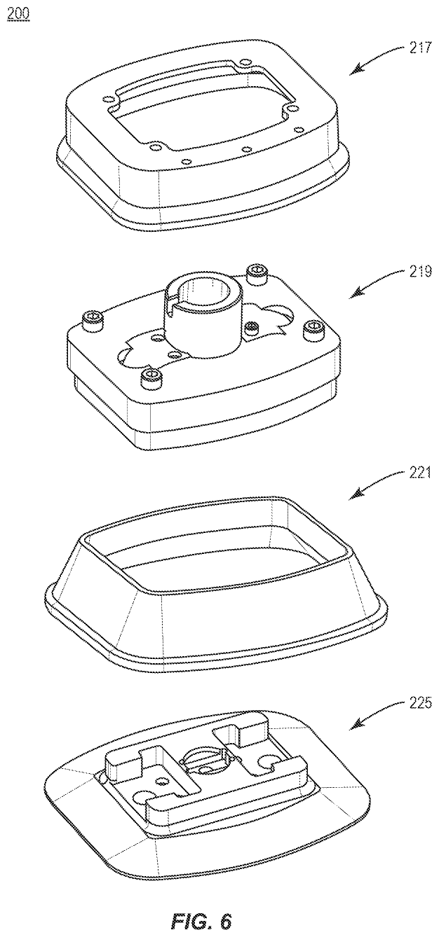

Referring additionally to FIGS. 4-10, the transmitting assembly 205 is illustrated according to an exemplary embodiment of the disclosure. As shown in the assembly view of FIG. 6, the transmitting assembly 205 can include a transmitting conductive member 217, a reciprocating member 219, a flexible member 221, and a plunger plate 225. The transmitting assembly 205 can be at least partially supported on an overhead support 226 such as rod, piston, frame member, etc.

As described further herein, an actuator movably coupled with or integrated with the overhead support 226 can cause the transmitting assembly 205 movably supported thereon to move upon receiving one or more electrical signals from a controller C in electrical communication (e.g., wired or wirelessly), with the transmitting assembly 205 and/or the receiving assembly 203. Such controller C can include a processor configured to implement one or more instructions stored on a non-transitory storage medium, and can be configured for operator input and/or manual control. In this regard, the controller C can be or can form a part of a software program running on a computer, a programmable logic controller (PLC), another processor-implemented controller, or other control feature. In some embodiments, the position of the overhead support 226 and transmitting assembly 205 can be configured for manual actuation, adjustment, etc.

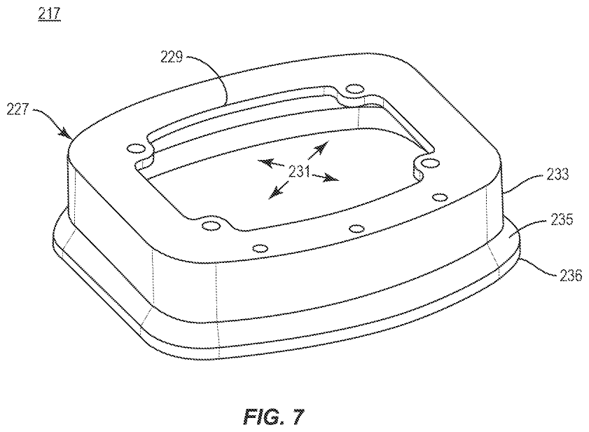

As shown in FIG. 7, the transmitting conductive member 217, as shown, can include have a generally annular shaped body 227 that defines an opening 229 in an upper surface thereof that is in communication with an interior 231. The body 227 of the transmitting conductive member 217 can have a generally vertical upper portion 233 and an outwardly sloping lower portion 235 that extends from the upper portion 231.

As also shown, the sloping lower portion 235 of the transmitting conductive member 217 can intersect and/or at least partially define an electrode feature 236 (broadly, “first electrode feature”). In this regard, the transmitting conductive member 217 can be formed of an at least partially electrically conductive material, for example, a metallic material such as copper, and can be configured for being electrically coupled to a power source P, e.g., a battery, generator, power grid, etc.

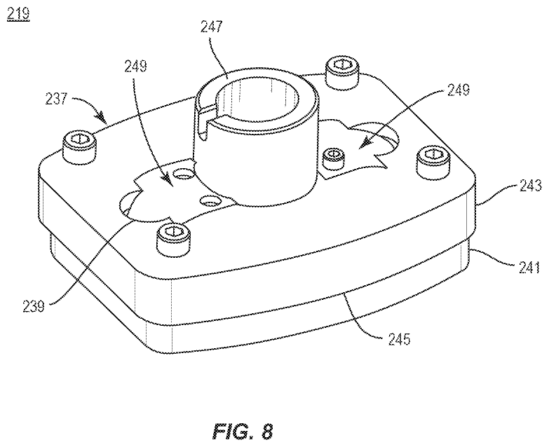

Referring to FIG. 8, the reciprocating member 219 can be a block-like member that is configured and arranged for being at least partially received in the interior 231 of the transmitting conductive member 217. As shown, the reciprocating member 219 can have a body 237 that at least partially defines an interior hollow or recess 239, a generally vertical lower portion 241, a generally vertical upper portion 243 extending outwardly from the lower portion 241 such that a flange or step 245 is defined thereby, and a collar 247 extending upwardly from the upper portion 243. As shown, the collar 247 can be arranged for at least partially receiving the support 226 such that the reciprocating member 219 and transmitting assembly 205 can be coupled thereto.

The upper portion 243 of the reciprocating member 219 can be configured for attachment to a pair of biasing members 249 that can be positioned extending through one or more openings in an upper surface of the upper portion 243 into the interior recess 239. In the illustrated embodiment, the biasing members 249 can be generally curved metallic or otherwise resilient materials, though a different configuration of biasing member, e.g., a coil spring or linear spring, could be provided without departing from the disclosure. As described further herein, the biasing members 249 facilitate the reciprocation of the reciprocating member 219 relative to other portions of the transmitting assembly 205. As also described herein, the biasing members 249 can facilitate electrical communication between components of the transmitting assembly 205.

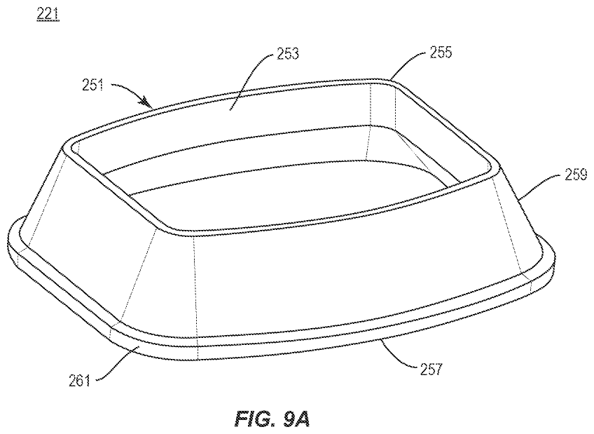

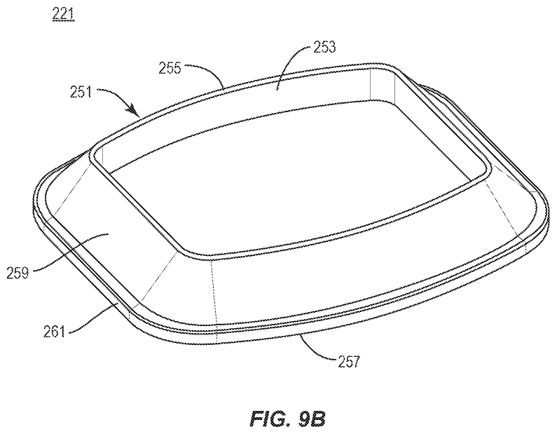

Turning to FIGS. 9A and 9B, the flexible member 221 can be an at least partially flexible and/or resilient member, e.g., formed of a polymeric material, that has a body 251 arranged in a generally annular configuration about an opening 253 extending therethrough. The opening 253 can extend from an upper edge or surface 255 of the body 251/member 221 to a lower edge or surface 257 of the body 251/member 221. As shown, a generally sloped sidewall 259 can extend from the upper surface 255 to a sealing feature 261 that protrudes outwardly from the sidewall 259 and defines the lower surface 257.

As described further herein, the flexible member 221 is reconfigurable between a first/initial/unstressed configuration, as shown in FIG. 9A, and a second/actuated/stressed configuration, as shown in FIG. 9B.

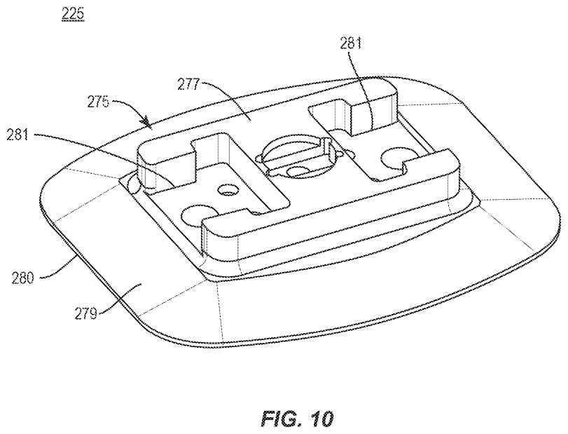

With additional reference to FIG. 10, the plunger plate 225 can have a body 275 with a protruding upper portion 277 and a generally sloped lower portion 279 extending from the upper portion 277. As described further herein, the protruding upper portion 277 can be configured for contact with a portion of the reciprocating member 219, and the lower portion 279 can be configured for contact with a barrier member during a sealing operation.

Furthermore, and as described further herein, the lower portion 279 of the plunger plate 225 can define an electrode feature 280 (broadly, “second electrode feature”). In this regard, the plunger plate 225 can be formed of an at least partially electrically conductive material, for example, a metallic material such as copper, and can be configured for being electrically coupled to the power source P, as described further below. In this regard, the transmitting conductive member 217, the plunger plate 225, and the power source P can form an electric circuit. In this regard, one or more portions of the transmitting assembly 205 can be connected to a ground source or ground element (not shown).

Upon formation of the transmitting assembly 205, the reciprocating member 219 can be at least partially received in the interior 231 of the transmitting conductive member 217 such that the collar 247 of the reciprocating member 219 can extend upwardly through the opening 229 in the transmitting conductive member 217 for at least partially receiving the support 226.

The flexible member 221 can be positioned extending at least partially around the lower portion 241 of the reciprocating member 219 such that the upper surface 253 is positioned for engagement with the step 245 of the reciprocating member 219. In such an arrangement, the flexible member 221 can also be at least partially received in the interior 231 of the transmitting conductive member 217 such that a portion of the transmitting conductive member 217 is coextensive with the sidewall 259 of the flexible member 221. In some embodiments, the flexible member 221 can be engaged in frictional and/or pressable engagement with the lower portion 241 of the reciprocating member 219. In some embodiments, the flexible member 221 can be at least partially attached to the lower portion 241 and/or the step 245 of the reciprocating member 219, for example, via adhesion with one or more adhesives, via welding, via interfering mechanical arrangement (e.g., via at least partial receipt in a groove or channel), etc.

The plunger plate 225 can also be at least partially positioned in the interior 231 of the transmitting conductive member 217. The protruding portion 277 of the plunger plate 225 can be configured for engagement with the lower portion 241 of the reciprocating member 219, either directly or via a connecting structure such as a post, rod, etc. In some embodiments, the protruding portion 227 of the plunger plate 225 can include a pair of recesses 281 for at least partially receiving a lower portion of the respective biasing members 249 so as to movably couple the reciprocating member 219 to the plunger plate 225. As also shown, the lower portion 279 of the plunger plate 225 can at least partially approximate the slope of the lower portion 235 of the transmitting conductive member 217.

The components of the transmitting assembly 205 can thus be assembled as described above, with one or more components connected to one another via engaging mechanical features and/or one or more fasteners such as bolts, screws, rivets, etc.

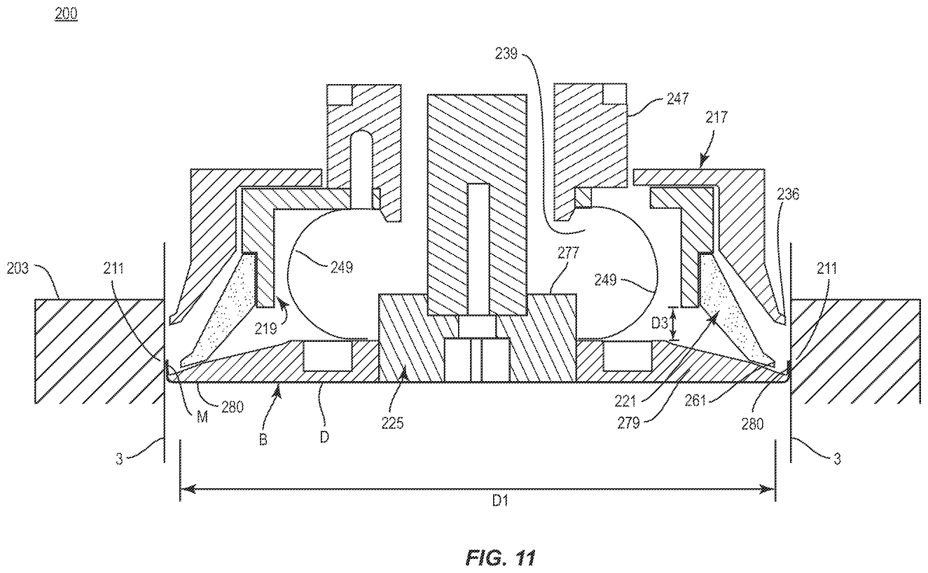

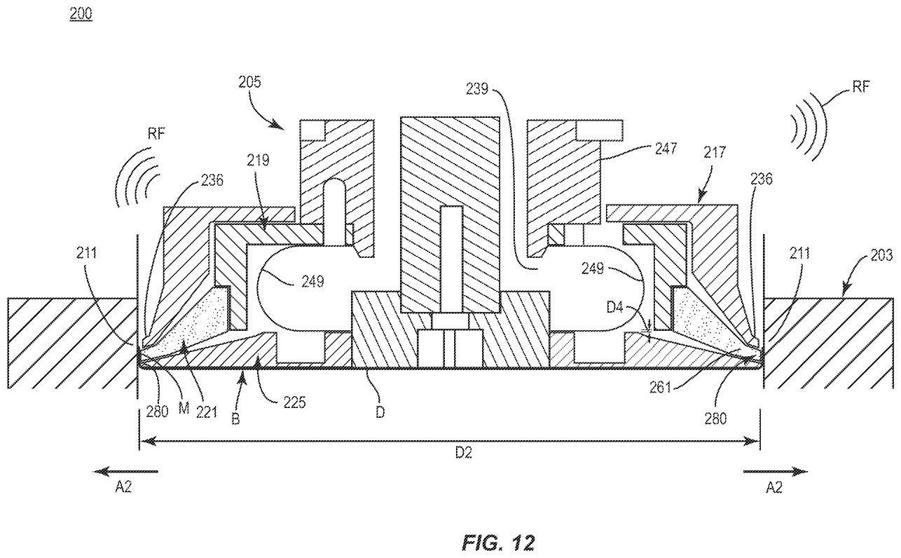

With additional reference to FIGS. 11 and 12, activation of the transmitting assembly 205 in the course of one or more sealing operations of the sealing assembly 200 will be described according to an exemplary embodiment of the disclosure.

A barrier member or barrier blank B can be positioned on a distal portion of the transmitting assembly 205, e.g., proximate the lower surface of the plunger plate 225. In some embodiments, the barrier member or barrier blank B can be attached to the transmitting assembly 205. The barrier member or barrier blank B, as shown, can include a central portion D and a marginal portion M. In some embodiments, the marginal portion M can be attached to the central portion D at one or more lines of weakening.

The container wall 3 associated with one or more containers or canisters, e.g., the container 1, can be arranged extending at least partially through the opening 213 of the receiving assembly 203 such that, as described further below, the transmitting assembly 205 can be positioned at least partially in the interior of the opening 213 interiorly of the container wall 3 such that at least a portion of the container wall 3 is positioned between the transmitting assembly 205 and the receiving assembly 203.

Upon receiving one or more signals from the controller C and/or via manual activation, the overhead support 226 can urge the transmitting assembly 205 downwardly toward the receiving assembly 203 in a direction indicated by the arrow A1 (FIG. 3). The transmitting assembly 205 can be inserted to a desired depth along the container wall 3, which, in some embodiments, can correspond to a vertical alignment with the receiving conductive member 211 of the receiving assembly 203. In such an arrangement, the marginal portion M of the barrier member or barrier blank B can catch or otherwise engage the upper edge of the container wall 3 and/or can frictionally engage an interior surface of the container wall 3 such that the marginal portion M of the barrier member or barrier blank B can extend upwardly relative to the central portion D of the barrier member or barrier blank B.

In some embodiments, a backpressure plate or other support can be provided interiorly of the container wall 3 to at least partially support the barrier member or barrier blank B and/or resist movement of the transmitting assembly 205 at a desired depth relative to the container wall 3.

Accordingly, and as shown in FIG. 12, when the lower surface of the transmitting assembly 205 meets such resistance, the support 226, via the collar 247 can press the reciprocating member 219 downwardly to cause the plunger plate 225 to move downwardly in the direction of the arrow A1.

As the lower portion 279 of the plunger plate 225 engages the barrier member or barrier blank B and any underlying supporting structure, continued movement of the support 226 can cause the reciprocating member 219 to compress the biasing members 249 to bring the reciprocating member 219 and plunger plate 225 into closer position with one another.

Such downward movement of the reciprocating member 219 relative to the plunger plate 225 can have the effect of carrying the flexible member 221 downwardly therewith, as well as the transmitting conductive member 217.

As the step 245 of the reciprocating member 225 urges the flexible member 221 further downwardly, the flexible member 221 can at least partially reconfigure from a first or initial configuration (shown in FIG. 9A) to a second configuration (shown in FIG. 9B) by sliding along the sloped lower portion 279 of the plunger plate 225 as to have a relatively wider footprint, e.g., such that the sealing feature 261 extends at least partially in the direction indicated by the arrows A2. Accordingly, the sealing feature 261 can have a first transverse direction D1 in the first configuration of the flexible member 221 and can have a second, greater transverse direction D2 in the second configuration of the flexible member 221. In this regard, the sealing feature 261 of the flexible member 221 can be urged to approach and/or compress the marginal portion M of the barrier member or barrier blank B against the container wall 3.

In this regard, while the plunger plate 225 remains in contact with the central portion D of the barrier member or barrier blank B, the transmitting conductive member 217 and the flexible member 221 have moved downwardly in the direction of the arrow A1, with the electrode feature 236 of the transmitting conductive member 217 and the electrode feature 280 of the plunger plate 225 brought into proximity, with the sealing feature 261 of the flexible member 221 positioned therebetween.

In this regard, the transmitting assembly 205 is reconfigurable from a first configuration (shown in FIG. 11), in which the reciprocating member is positioned a first vertical distance D3 above the plunger plate 225, and a second configuration (shown in FIG. 12), in which the reciprocating member 219 is positioned a second vertical distance D4 above the plunger plate 225.

In the second configuration of the transmitting assembly 205, the power source P can provide an electrical signal to the transmitting conductive member 217 and the plunger plate 225 to produce a desired electric field having the effect of generating one or more electromagnetic waves, e.g., radio waves RF. In some embodiments, the biasing members 249 can be comprised of an electrically conductive material, e.g., a metallic material, such that the transmitting conductive member 217 and the plunger plate 225 can be in electrical communication via the biasing members 249 extending therebetween.

In some embodiments, such RF waves can have a frequency between about 30 Hz and about 300 GHz, though the RF wave(s) can be provided with a different wavelength without departing from the disclosure. In one embodiment, the RF wave(s) can have a wavelength of about 27.12 MHz.

In some embodiments, the power source P can provide one or more electric pulses to provide the RF wave(s) having the desired properties. In some embodiments, the power source P can provide such electric pulses in coordination with a suitable controller, e.g., the controller C or a separate controller. In some embodiments, such controller can be configured to provide electric current to the transmitting assembly 205 so as to produce RF wave(s) having the general waveform of a square wave, e.g., so as to minimize energy spikes. In some embodiments, one or more inert gases, carbon dioxide, periodic Group 18 gases, etc., can be provided in proximity to the electrode features 236, 280 to minimize the occurrence and/or effect of electrical arcing.

Such generated RF wave(s) proximate the electrode features 236, 280 can transmit/emanate outwardly, through the marginal portion M of the barrier member or barrier blank B, and be absorbed by the receiving assembly 203, e.g., at the conductive element 211. Such transmission of the RF wave(s) through the marginal portion M of the barrier member or barrier blank B positioned between the transmitting assembly 205 and the receiving assembly 203 can have the effect of exciting molecules associated with one or more polymeric portions of the barrier member or barrier blank B to cause such polymeric portions thereof to heat and at least partially soften and/or melt, with the pressing action of the sealing feature 261 of the flexible member 221 having the effect of adhering the marginal portion M of the barrier member or barrier blank B to the container wall 3 via such softened and/or melted portions thereof.

When a predetermined sealing or curing time has elapsed, the overhead support 226 can cease to exert pressure on the transmitting assembly 205 and/or withdraw, for example, under action of the controller C, such that the biasing members 249 resiliently return from a compressed state to an initial state such that at least the reciprocating member 219 and the transmitting conductive member 217 can move upwardly relative to the barrier member or barrier blank B. Such movement of the reciprocating member 219 can cause the flexible member 221 to resiliently return to an initial configuration in which the sealing feature 261 of the flexible member 221 moves away from the marginal portion M of the barrier member or barrier blank B and the container wall 3. In this regard, the biasing members 249 are positioned to bias the transmitting assembly 205 from the second configuration to the first configuration.

As described herein, the barrier member or barrier blank B can have the configuration of a laminate construct or laminate structure including at least one polymeric layer laminated to at least one other layer. In some embodiments, the laminate structure that forms the barrier member or barrier blank B can include at least one composite layer in addition to the at least one polymeric layer, e.g., an arrangement of cellulosic fibers, a paper or paper-based product such as paperboard, cardboard, etc. In some embodiments, the at least one polymeric layer of the laminate structure that forms the barrier member or barrier blank B can include one or more additional polymeric layers. In some embodiments, the at least one polymeric layer of the laminate structure that forms the barrier member or barrier blank B can include copolymers of ethylene or methyl acrylate. In some embodiments, the barrier blank B can have an arrangement the same as or similar to that of the laminate structure 102 described herein.

In some embodiments, it will be understood that one or more of the blanks and members described herein can be shaped, sized, or otherwise configured to engage other container structures that include a container wall 3. Such container structures can include Boardio®, available from Graphic Packaging International, LLC of Atlanta, GA, Sealio®, available from Graphic Packaging International, LLC of Atlanta, GA, and Cekacan®, available from Graphic Packaging International, LLC of Atlanta, GA, to name a few. In some embodiments, the container wall 3 can have a board surface weight from about 170 g/m² to about 500 g/m².

It will be understood that the sealing assembly 200 can have a different arrangement without departing from the disclosure. For example, in some embodiments, the sealing assembly 200 can be provided without the transmitting conductive member 217, with the reciprocating member 219 acting in concert with the plunger plate 225 to produce RF energy as described herein, e.g., such that the reciprocating member 219 can provide or define an electrode feature. As another example, in some embodiments, power P can be supplied to the receiving assembly 203 for generating RF energy received by the transmitting assembly 205, having the same or similar effect to the seal one or more portions of the blank B to a container wall 3.

In general, the blanks or base layers described herein may be constructed from paperboard having a caliper so that it is heavier and more rigid than ordinary paper. The base layer can also be constructed of other materials, such as cardboard, or any other material having properties suitable for enabling the construct to function at least generally as described above. The base layer can be coated with, for example, a clay coating. The clay coating may then be printed over with product, advertising, and other information or images. The base layers may then be coated with a varnish to protect information printed on the base layers. The base layers may also be coated with, for example, a moisture barrier layer, on either or both sides of the base layers. The base layers can also be laminated to or coated with one or more sheet-like materials at selected panels or panel sections.

It will be apparent that numerous other sequences of steps may be used to form constructs as described herein. It also will be apparent that numerous other materials or structures may be used to form a construct in accordance with the disclosure. Any of such materials may be used alone or in combination, and in any configuration, to form the construct. Where multiple materials (or multiple layers of the same material) are used, the materials may be joined to one another partially or completely, or may remain separate from one another (i.e., unjoined).

The laminate structures and blanks/constructs disclosed herein may be formed according to numerous processes known to those in the art, and any of the various components used to form the package may be provided as a sheet of material, a roll of material, or a die cut material in the shape of a construct to be formed (e.g., a blank or base layer).

All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present disclosure, and do not create limitations, particularly as to the position, orientation, or use of the disclosed embodiments unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present disclosure.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A laminate structure for forming a barrier member of a container, the laminate structure comprising:
a base layer;
a barrier film layer;
a first functional polymer layer; and
a second functional polymer layer configured to at least partially seal the laminate structure to a container wall of the container,
the first functional polymer layer reactive to the application of radiofrequency energy for promoting joining the second functional polymer layer to the container wall of the container.

2. The laminate structure of claim 1, wherein the first functional polymer layer is configured to at least partially melt when subjected to radiofrequency energy.

3. The laminate structure of claim 2, the barrier film layer being adhered to the base layer, the first functional polymer layer being applied to the barrier film layer, and the second functional polymer layer being applied to the first functional polymer layer.

4. The laminate structure of claim 3, wherein the first functional polymer layer comprises a copolymer of ethylene and methyl acrylate.

5. The laminate structure of claim 3, wherein the copolymer of ethylene and methyl acrylate comprises above about 15% methyl acrylate by weight.

6. The laminate structure of claim 5, wherein the first functional polymer layer is present in an amount of between about 2 g/m² and about 50 g/m².

7. The laminate structure of claim 6, wherein the second functional polymer layer comprises one or more polyolefins.

8. The laminate structure of claim 7, wherein the barrier film layer comprises a carrier film and at least one barrier deposited on the carrier film, the at least one barrier selected from the group consisting of aluminum, silicone oxide, and aluminum oxide.

9. A container for holding one or more products, the container comprising:
a container body comprising a container wall extending at least partially around an interior of the container;
a top end;
a bottom end; and
a barrier member positioned in the interior of the container, the barrier blank comprising:
a base layer;
a barrier film layer;
a first functional polymer layer; and
a second functional polymer layer configured to at least partially seal the laminate structure to the container wall of the container,
the first functional polymer layer reactive to the application of radiofrequency energy for promoting joining the second functional polymer layer to the container wall of the container.

10. The container of claim 9, wherein the first functional polymer layer is configured to at least partially melt when subjected to radiofrequency energy.

11. The container of claim 10, the barrier film layer being adhered to the base layer, the first functional polymer layer being applied to the barrier film layer, and the second functional polymer layer being applied to the first functional polymer layer.

12. The container of claim 11, wherein the first functional polymer layer comprises a copolymer of ethylene and methyl acrylate.

13. The container of claim 11, wherein the copolymer of ethylene and methyl acrylate comprises above about 15% methyl acrylate by weight.

14. The container of claim 13, wherein the first functional polymer layer is present in an amount of between about 2 g/m² and about 50 g/m².

15. The container of claim 14, wherein the second functional polymer layer comprises one or more polyolefins.

16. The container of claim 15, wherein the barrier film layer comprises a carrier film and at least one barrier deposited on the carrier film, the at least one barrier selected from the group consisting of aluminum, silicone oxide, and aluminum oxide.

17. A method of forming a container for holding one or more products, the method comprising:
obtaining a container wall;
positioning the container wall extending at least partially around an interior of the container and such that the container has a top end and a bottom end;
obtaining a barrier blank, the barrier blank comprising:
a base layer;
a barrier film layer;
a first functional polymer layer; and
a second functional polymer layer, the first functional polymer layer reactive to the application of radiofrequency energy;
positioning the barrier blank at least partially in the interior of the container; and
applying radiofrequency energy to the barrier blank to join the second functional polymer layer to the container wall of the container.

18. The method of claim 17, wherein applying radiofrequency energy to the barrier blank comprises at least partially melting the first functional polymer layer.

19. The method of claim 18, the barrier film layer being adhered to the base layer, the first functional polymer layer being applied to the barrier film layer, and the second functional polymer layer being applied to the first functional polymer layer.

20. The method of claim 19, wherein the first functional polymer layer comprises a copolymer of ethylene and methyl acrylate.

21. The method of claim 19, wherein the copolymer of ethylene and methyl acrylate comprises above about 15% methyl acrylate by weight.

22. The method of claim 21, wherein the first functional polymer layer is present in an amount of between about 2 g/m² and about 50 g/m².

23. The method of claim 22, wherein the second functional polymer layer comprises one or more polyolefins.

24. The method of claim 23, wherein the barrier film layer comprises a carrier film and at least one barrier deposited on the carrier film, the at least one barrier selected from the group consisting of aluminum, silicone oxide, and aluminum oxide.

25. A sealing assembly for sealing a portion of a barrier blank to a container wall, the sealing assembly comprising:
a receiving assembly, the receiving assembly comprising a support defining an opening, and a receiving conductive member positioned extending at least partially around the opening; and
a transmitting assembly, the transmitting assembly comprising a transmitting conductive member defining a first electrode feature, a reciprocating member, a flexible member defining a sealing feature and positioned between the conductive member, and a plunger plate defining a second electrode feature,
the transmitting assembly movably supported relative to the receiving assembly such that the transmitting assembly is for being aligned with the receiving conductive member in the opening of the support so that at least one radiofrequency wave is for being transmitted from the first electrode feature and the second electrode feature of the transmitting assembly to the conductive member of the receiving assembly to heat one or more portions of a barrier blank positioned therebetween.

26. The sealing assembly of claim 25, wherein the conductive member has a body defining an interior, the reciprocating member and the flexible member at least partially received in the interior of the conductive member.

27. The sealing assembly of claim 26, wherein the reciprocating member is attached to the flexible member such that the flexible member is reconfigurable upon movement of the reciprocating member.

28. The sealing assembly of claim 27, wherein the flexible member is reconfigurable between a first configuration, wherein the sealing feature defines a first transverse distance, and a second configuration, wherein the sealing feature defines a second transverse distance, the second transverse distance greater than the first transverse distance.

29. The sealing assembly of claim 28, wherein the plunger plate has a body defining an at least partially sloped outer surface, the sealing feature of the flexible member is configured to slidably move along the sloped outer surface of the body of the plunger plate when the flexible member reconfigures between the first configuration and the second configuration.

30. The sealing assembly of claim 29, wherein the reciprocating member is movably coupled to the plunger plate with at least one biasing member.

31. The sealing assembly of claim 30, wherein the transmitting assembly is reconfigurable between a first configuration, in which the reciprocating member is spaced a first vertical distance above the plunger plate, and a second configuration, in which the reciprocating member is positioned a second vertical distance above the plunger plate, the first vertical distance greater than the second vertical distance.

32. The sealing assembly of claim 31, wherein the first electrode feature and the second electrode feature are arranged to transmit the at least one radiofrequency wave to the receiving conductive member when the transmitting assembly is in the second configuration.

33. The sealing assembly of claim 32, wherein the at least one biasing member is positioned to bias the transmitting assembly into the first configuration.

34. A method of sealing a barrier blank to a container wall of a container, the method comprising:
obtaining a sealing assembly, the sealing assembly comprising:
a receiving assembly, the receiving assembly comprising a support defining an opening, and a receiving conductive member positioned extending at least partially around the opening; and
a transmitting assembly, the transmitting assembly comprising a transmitting conductive member defining a first electrode feature, a reciprocating member, a flexible member defining a sealing feature and positioned between the conductive member, and a plunger plate defining a second electrode feature, the transmitting assembly movably supported relative to the receiving assembly;
aligning the transmitting assembly with the receiving conductive member in the opening of the support;
positioning a barrier blank and a container wall at least partially between the transmitting assembly and the receiving assembly; and
transmitting at least one radiofrequency wave from the first electrode feature and the second electrode feature of the transmitting assembly to the conductive member of the receiving assembly to heat one or more portions of the barrier blank.

35. The method of claim 34, wherein the conductive member has a body defining an interior, the reciprocating member and the flexible member at least partially received in the interior of the conductive member.

36. The method of claim 35, wherein the reciprocating member is attached to the flexible member such that the flexible member is reconfigurable upon movement of the reciprocating member.

37. The method of claim 36, further comprising moving the reciprocating member such that the flexible member is reconfigured from a first configuration, wherein the sealing feature defines a first transverse distance, to a second configuration, wherein the sealing feature defines a second transverse distance, the second transverse distance greater than the first transverse distance.

38. The method of claim 37, wherein the plunger plate has a body defining an at least partially sloped outer surface, and moving the reciprocating member comprises slidably moving the sealing feature of the flexible member along the sloped outer surface of the body of the plunger plate.

39. The method of claim 38, wherein the reciprocating member is movably coupled to the plunger plate with at least one biasing member.

40. The method of claim 39, further comprising reconfiguring the transmitting assembly from a first configuration, in which the reciprocating member is spaced a first vertical distance above the plunger plate, to a second configuration, in which the reciprocating member is positioned a second vertical distance above the plunger plate, the first vertical distance greater than the second vertical distance.

41. The method of claim 40, wherein the first electrode feature and the second electrode feature are arranged to transmit the at least one radiofrequency wave to the receiving conductive member when the transmitting assembly is in the second configuration.

42. The method of claim 41, wherein the at least one biasing member is positioned to bias the transmitting assembly toward the first configuration.
